(19) United States
(12) Patent Application Publication
(10) Pub. No.: US 2021/0088065 A1
(43) Pub. Date: Mar. 25, 2021

(54) ACCESSORY MOUNT AND REPAIR DEVICE FOR A TELESCOPING POLE

(71) Applicant: Nicholas DeLuca, Oceanside, CA (US)

(72) Inventor: Nicholas DeLuca, Oceanside, CA (US)

(21) Appl. No.: 16/578,113

(22) Filed: Sep. 20, 2019

(51) Int. Cl. F16B 7/10; F16B 1/00; A45F 3/00; E04H 15/44

(52) U.S. Cl. CPC F16B 7/105; F16B 1/00; F16B 2001/0028; E04H 15/44; A45F 3/00

(57) ABSTRACT

A device for repairing a telescopic pole or attaching an accessory thereto, the device including a peg secured to a flexible strap, the peg configured to be inserted into a peg hole opening of a telescopic pole, after which the flexible strap is wrapped around the telescopic pole and fastened together to secure the peg in the peg hole and secure the device to the pole. The strap includes a fastening mechanism such as a clip, hook or adhesive fastener to secure the flexible strap to the pole and keep the peg securely inserted into the peg hole opening. Additionally, one or more accessories may be attached with the flexible strap to provide additional functionality when the device is attached with the pole, such as a pouch, pocket, loop or hook to hold cups, cans or other items.

### BACKGROUND

### Field of the Invention

Devices and methods provided herein relate to accessories for perforated poles, and more specifically a device for mounting accessories to perforated poles and repairing telescopic poles.

### Related Art

A canopy or pop-up tent is a temporary shelter that can be easily and quickly assembled in order to provide protection from sun or rain. As shown in the example in FIG. 1, the canopy tent 100 typically includes a fabric canopy top 102 supported by four telescopic poles 104 at a length that allows one or more persons to stand beneath it. When setting up the canopy tent, the telescopic poles are expanded and locked into an extended position while the canopy top is expanded from folded support arms into a sloped canopy shape with a highest point at a center of the canopy. FIG. 2 illustrates a telescopic pole assembly 104 in an extended position, with an interior pole 104A extended from within the housing of the exterior pole 1048 and then locked in position with a locking peg 106 which protrudes from inside the interior pole 104A and through a peg hole opening in the exterior pole. The locking peg 106 fixes the interior pole 104A and exterior pole 104B in a selected position corresponding to one of several peg holes 108 located on one side of the exterior pole. Thus, the height of the canopy tent can be adjusted by sliding the interior pole 104A until the locking peg 106 aligns and fits into a different peg hole 108.

In order to continuously adjust the telescopic pole into different positions, the locking peg 106 may be configured as shown in FIG. 3 and FIG. 4, with a V-shaped spring clip 110 positioned within the interior pole 104A and the locking peg 106 positioned at a distal end of the clip 300 so that the spring clip forces the locking peg into the peg hole opening 112 of the interior pole 104A and peg hole opening 112 of the exterior pole 104B. When the telescopic pole is to be adjusted, a user simply depresses the locking peg 106 back through the peg hole opening until the interior pole 104A can be moved relative to the exterior pole 1046 until a desired height is selected and the locking peg 106 protrudes through another outer peg hole.

One disadvantage of the canopy tent is its limited functionality. Without any walls or floor, it is designed simply as a temporary shelter in an outdoor environment. As most users intend to use the canopy for outdoor recreation, there is a need for improvements to the canopy tent to make it more useful for the activities in which it is so often used.

Additionally, the telescopic pole design suffers from numerous limitations and flaws, the most significant of which is that the V-shaped spring clip 300 often breaks or becomes dislodged within the interior pole 104A. Without the peg protruding through the peg hole, the telescopic pole is essentially useless, as it cannot be locked into any position other than its shortest, un-extended position. Even with the three other telescopic poles functioning correctly, the failure of just one of the telescopic poles renders the entire canopy mostly useless as well, as the height of the canopy will be uneven and significantly lower on one of the four sides.

Currently, the only way to repair a broken telescopic pole is to purchase replacement pegs or spring clips, completely disassemble the product and try to replace the clip internally. This type of repair is daunting and complicated for most people, which effectively leads them to dispose of the entire canopy tent and purchase a new one or effectuate a crude repair—such as by taping the poles together with duct tape—that requires difficult removal and replacement each time the canopy tent is taken down and put up. Therefore, there is a need for improved devices and methods of repairing telescopic poles for canopy tents.

### SUMMARY

Embodiments described herein provide a device for attaching with a perforated pole, the device including a peg secured to a flexible strap with a fastening mechanism, the peg configured to be inserted into a peg hole opening of the perforated pole and the flexible strap configured to wrap around the perforated pole and fasten together with the fastening mechanism to secure the peg in the peg hole. The fastening mechanism may include a clip, hook or adhesive fastener to secure the flexible strap to the pole and keep the peg securely inserted into the peg hole opening. If the perforated pole is a telescopic pole assembly where an interior pole slides within an exterior pole, the device may be utilized to fix the interior pole at a certain position within the exterior pole, especially if the existing spring clip is broken. Additionally, one or more accessories may be attached with the flexible strap—such as a pouch, pocket, loop or hook—to provide storage for beverages, tools and other items common to use with a canopy tent.

In one embodiment, a device for attaching with a perforated pole comprises: a flexible strap with a fastening mechanism for fastening one portion of the flexible strap with a second portion of the flexible strap; and a peg secured with the flexible strap on a first end and protruding substantially perpendicularly from the flexible strap.

In another embodiment, a method of attaching an accessory with a perforated pole comprises: position peg attached with a flexible strap and accessory over an exterior peg hole of a perforated pole; insert peg into the exterior peg hole; wrap the flexible strap with the attached accessory around an exterior surface of the perforated pole; and fasten the flexible strap to secure the accessory to the perforated pole.

In a further embodiment, a method of repairing a telescopic pole comprises: aligning an interior peg hole on an interior pole with an exterior peg hole on an exterior pole; inserting a peg attached with a flexible strap into the exterior peg hole and interior peg hole; wrapping the flexible strap around an exterior surface of the exterior pole; and fastening the flexible strap around the exterior pole to secure the peg in the peg hole.

Other features and advantages of the present invention will become more readily apparent to those of ordinary skill in the art after reviewing the following detailed description and accompanying drawings.

### BRIEF DESCRIPTION OF THE DRAWINGS

The structure and operation of the present invention will be understood from a review of the following detailed description and the accompanying drawings in which like reference numerals refer to like parts and in which:

FIG. 1 is an illustration of a canopy or pop-up tent, as is known in the art;

FIG. 2 is an illustration of a telescopic leg of a canopy tent, as is known in the art;

FIG. 3 is an illustration of spring clip with a locking peg for use with the telescopic leg, as is known in the art;

FIG. 4 is a cross-sectional illustration of the telescopic leg with the spring clip positioned therein, as is known in the art;

FIG. 5 is a perspective view illustration of a pole attachment device, with a peg, flexible strap and fastening mechanism, according to one embodiment of the invention;

FIG. 6A is a flow diagram illustrating an example method of attaching the device with a perforated pole, according to an embodiment of the invention;

FIG. 6B is a flow diagram illustrating an example method of attaching the device with a telescopic pole, according to an embodiment of the invention;

FIG. 7 is image of the device and a threaded peg prior to insertion into a peg hole of the telescopic pole, according to one embodiment of the invention;

FIG. 8 is a perspective view illustration of the peg being inserted into the peg hole, according to one embodiment of the invention;

FIG. 9 a perspective view illustration of the flexible strap being wrapped around the telescopic pole after insertion of the peg, according to one embodiment of the invention;

FIG. 10 a perspective view illustration of the fastening mechanism on the flexible strap being fastened together to secure the device with the telescopic pole, according to one embodiment of the invention;

FIG. 11 a cross-sectional view of the pole attachment device inserted into a telescopic pole, according to one embodiment of the invention;

FIG. 12 is an image of a cup holder accessory attached with the flexible strap of the pole attachment device, according to one embodiment of the invention;

FIG. 13 is an image of the cup holder accessory being attached with the perforated pole as the flexible strap is wrapped around the pole, according to one embodiment of the invention;

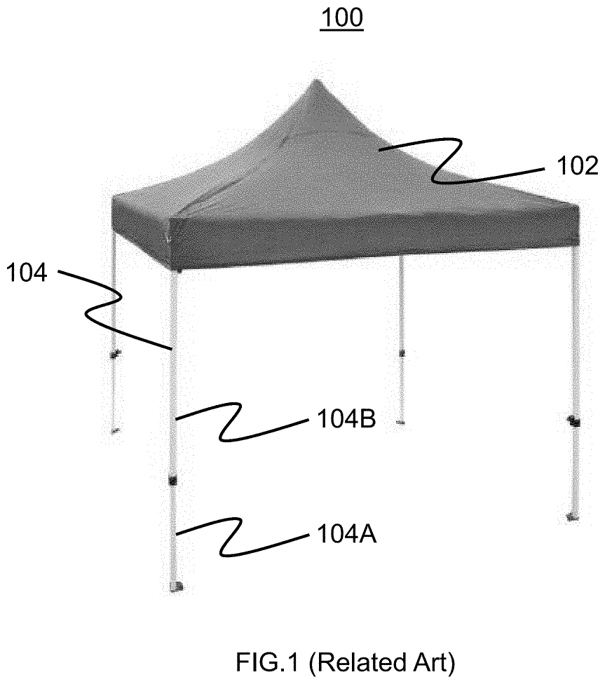

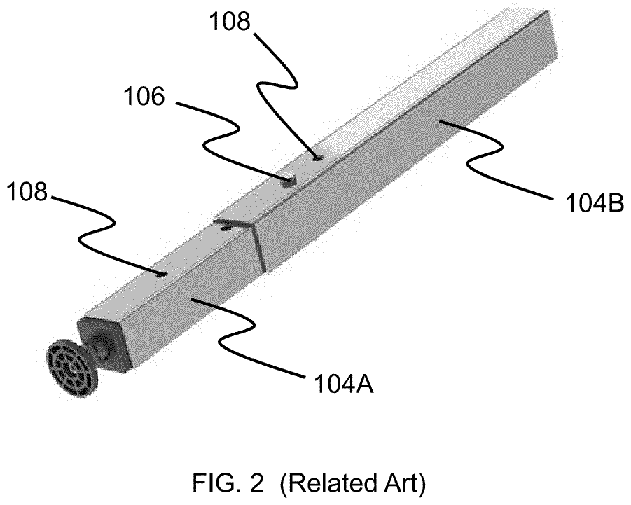

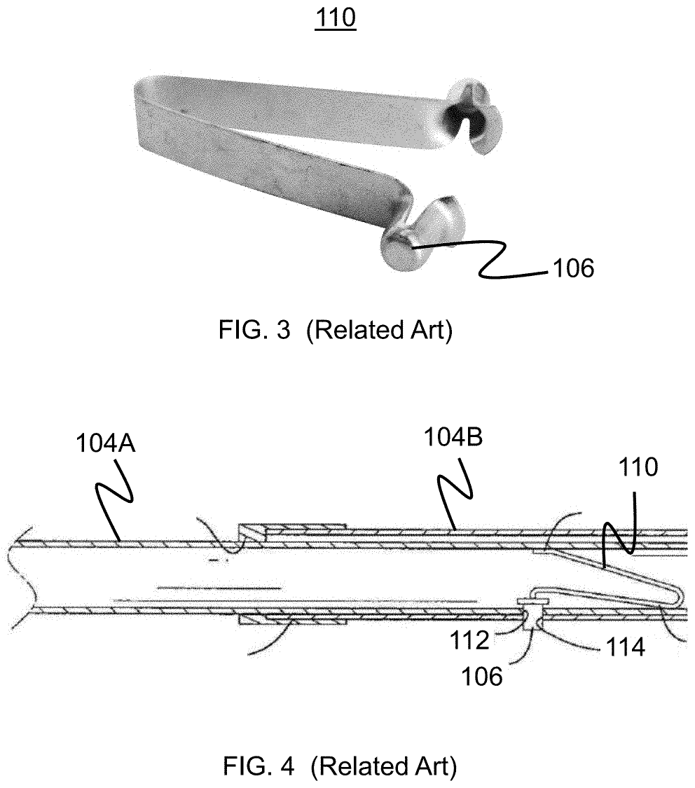

### DETAILED DESCRIPTION

Embodiments described herein provide a pole attachment device for attaching with a perforated pole, the device including a peg secured with a flexible strap and a fastening mechanism positioned on the flexible strap for securing the device to the perforated pole, wherein the peg is inserted into a peg hole opening of the perforated pole and the flexible strap is wrapped around the outer surface of the pole and then fastened together with the fastening mechanism to secure the device to the pole. The fastening mechanism may include a clip, hook or adhesive fastener to secure the flexible strap to the pole and keep the peg securely inserted into the peg hole opening.

The pole attachment device may be utilized as a repair device for a telescopic pole by inserting the peg into a peg hole of an interior pole and a peg hole of an exterior pole, thus fixing the position of the interior pole and exterior pole. This is particularly advantageous for a telescopic pole on a canopy tent where the spring clip or locking peg are no longer functioning, as it allows the non-functioning telescopic pole to be locked into any potential position in conjunction with the other properly-functioning poles, thus maintaining the use of the canopy tent.

Additionally, the pole attachment device may serve as an accessory holder to hold one or more accessories with material attached with the flexible strap. The accessory may serve a variety of purposes such as a pouch, pocket, cup holder, loop or hook.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

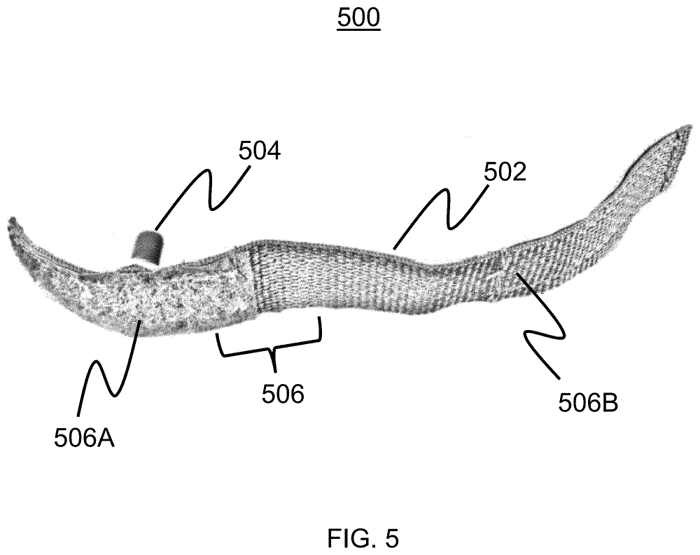

FIG. 5 illustrates one embodiment of a pole attachment device 500, with a flexible strap 502 made from a length of multi-layered fabric and a peg 504 secured on a first end with the flexible strap 502 with a second end protruding substantially perpendicularly from the strap 502. The strap 502 may also include a fastening mechanism 506 which secures one portion of the strap 502 to another portion when the strap is wrapped around the perforated pole, as shown below. In this embodiment, the fastening mechanism 506 is a fabric adhesive such as Velcro®, with a first portion 506A made from a fabric material configured to securely but removably attach with a second portion 506B once the length of the strap is wrapped around the pole one or more times. In this manner, the device 500 may be easily secured to the pole during setup of a canopy tent and then easily removed when the canopy tent is taken down.

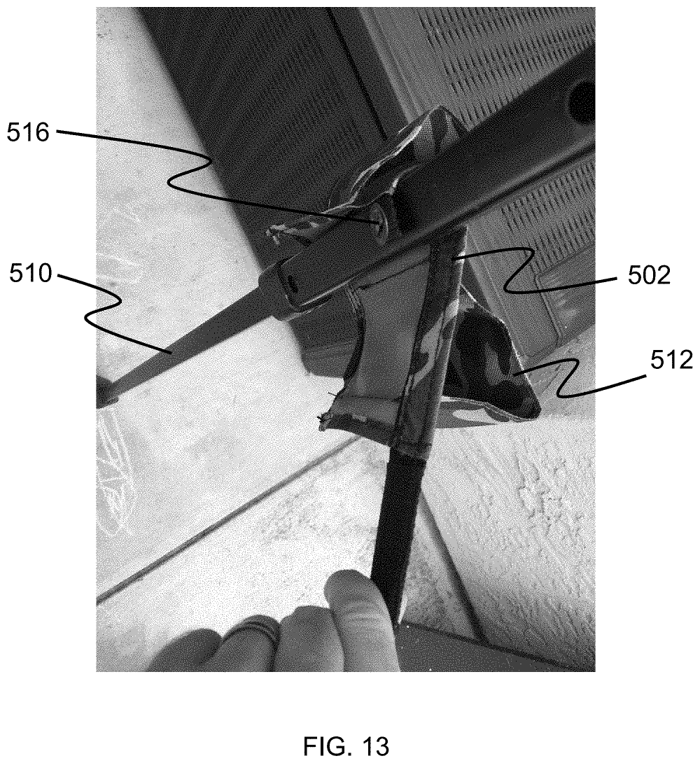

The flexible strap may be formed from a multi-layered length of durable fabric such as nylon or polyester to provide a flexible, stretchable and weatherproof material suitable for use outdoors and with sufficient strength to remain attached to the perforated pole. The multiple layers of fabric may be useful for attaching the first end of the peg to the flexible strap by inserting it between the layers. The first end of the peg may have a wider diameter than the rest of the peg in order to retain the peg within the flexible strap. In another embodiment, the peg may protrude through the flexible strap and be fastened with the strap on an opposing side with a grommet or other fixing mechanism, as shown below in FIG. 13. Additional fastening mechanisms may also be used, such as clips, buckles, hooks, snaps, buttons, cinching straps, draw strings, etc., although the use of adhesive fabrics simplifies the device by integrating the fastening mechanism into the flexible strap itself.

The peg may be a smooth, rounded metal, aluminum or plastic piece with similar diameter and length to a peg used in the existing perforated pole. The diameter and length may therefore vary depending on the size, type and model of canopy tent and perforated pole, although it is envisioned that a certain diameter and length could be applied universally to the vast majority of perforated poles. In one embodiment, a bolt or screw may be used as the peg so that the first end of the peg has the larger diameter needed to secure the peg into the flexible strap. The body of the peg may therefore be threaded or barbed in order to more securely fit and maintain the peg into a peg hole on the perforated pole or to more securely retain the peg in the peg holes of an exterior pole and interior pole of a telescopic pole.

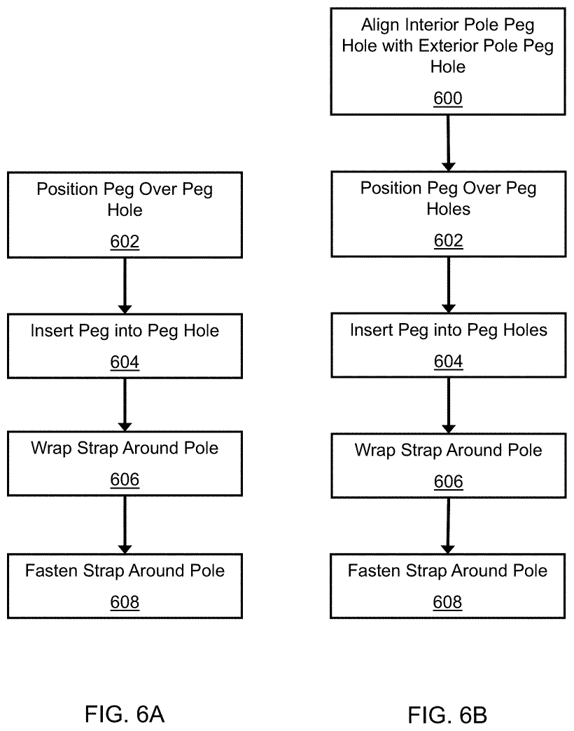

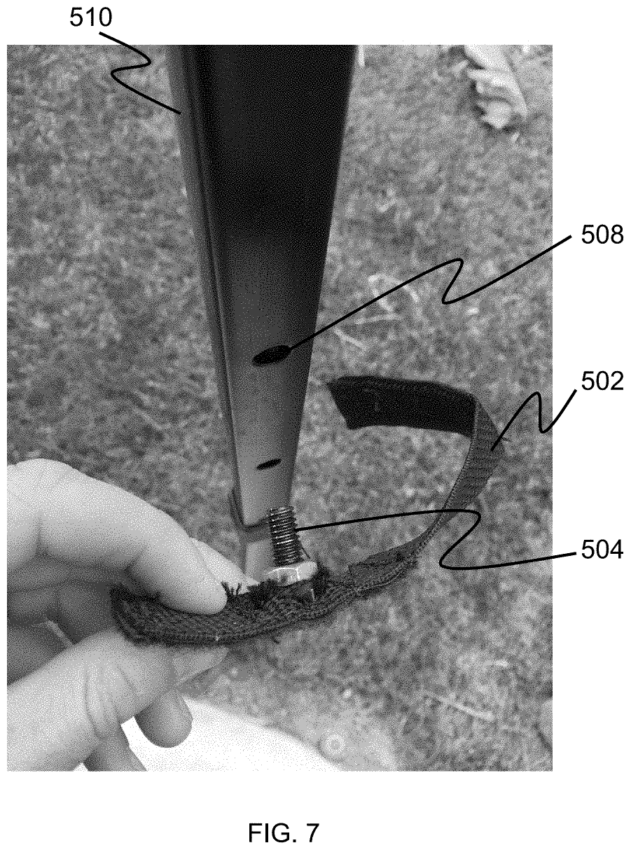

FIG. 6A is a flow diagram of a method of attaching the pole attachment device to a perforated pole, while FIG. 6B is a flow diagram of a method of attaching the pole attachment device to a telescopic pole to repair a broken spring clip or peg, as illustrated by the images in FIG. 7-FIG. 10. The primary difference in the two methods is that attaching the device to repair a telescopic pole requires a first step 600 of aligning an interior peg hole of an interior telescopic pole with an exterior peg hole of an exterior telescopic pole so that the peg holes line up. The peg holes should be lined up if the device is intended to fix the position of the interior telescopic pole with the exterior telescopic pole, for example when the spring clip of the interior telescopic pole is broken or has become dislodged from its intended position and no longer protrudes out of the interior peg hole. If the device is being attached to a perforated pole or telescopic pole simply to attach an accessory to the pole, the method begins at step 602 below and the device can be inserted into any exterior peg hole without needing to align it with an interior peg hole.

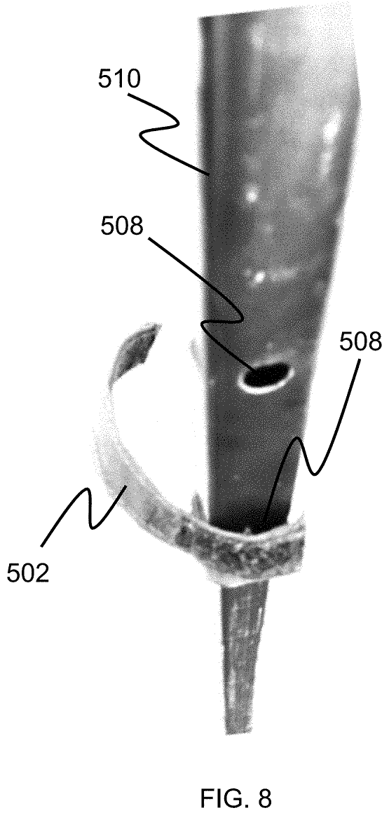

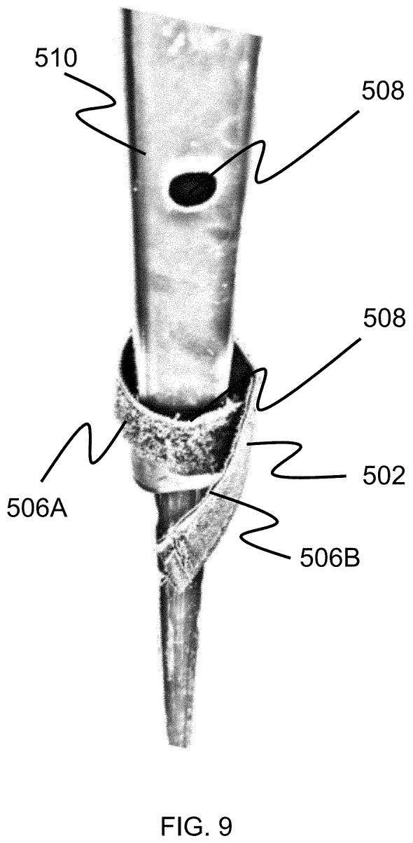

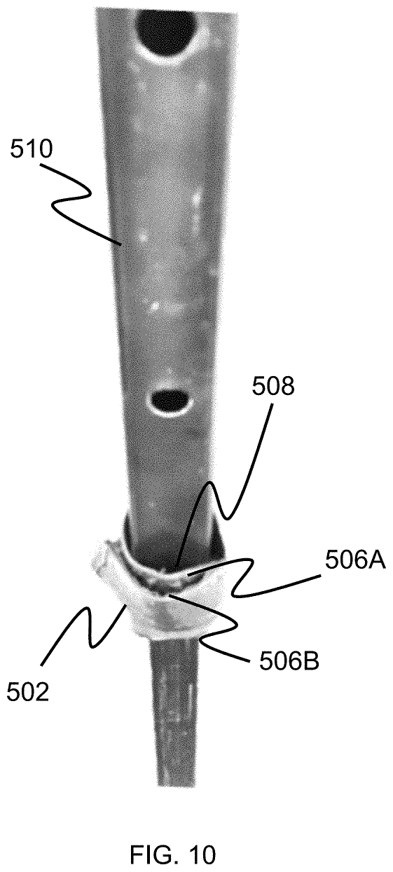

In step 602 and as shown in FIG. 7, the peg 504 is positioned over a peg hole 508 of a perforated pole 510 (or telescopic pole 104). A user can simply hold the flexible strap 502 in order to align the peg 504 with the peg hole 508. FIG. 7 additionally shows a threaded bolt as the peg 504. In step 604, illustrated in FIG. 8, the peg 504 is inserted into the peg hole 508 of the perforated pole 510 so that only the flexible strap 502 is visible. In step 606, illustrated in FIG. 9, the flexible strap 502 is wrapped around the perforated pole 510 to more firmly secure the peg 504 into the peg hole. Depending on the length of the flexible strap 502, the strap 502 may wrap around the perforated pole 510 several times. FIG. 9 also demonstrates the position of the fabric adhesive materials once the flexible strap has been wrapped around the perforated pole 510, with the first portion 506A facing the exterior of the strap 502 and the second portion 506B on the subsequent length of the strap 502 facing the interior of the strap 502 and overlapping with the first portion 506A. In step 608, as illustrated in FIG. 10, the first portion 506A of the fastening mechanism 506 is secured to the second portion 506B and the flexible strap 502 is secured to the perforated pole 510.

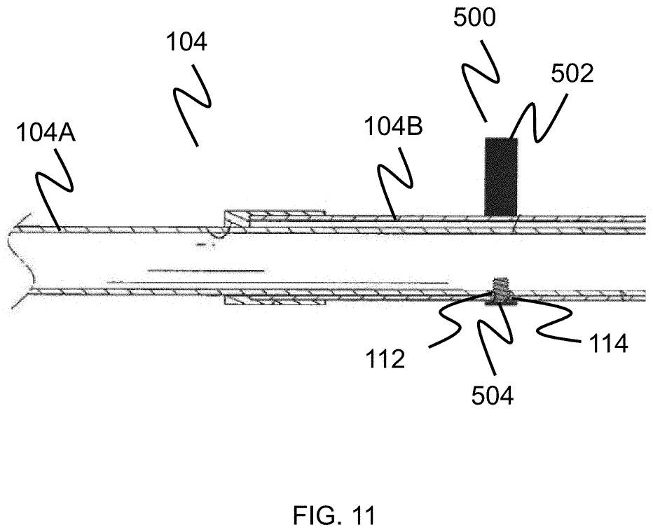

FIG. 11 is a cross-sectional illustration of the telescopic pole 104 from FIG. 4 with the pole attachment device 500 fixed thereto, showing the position of the peg 504 inserted through the exterior peg hole 114 of the exterior pole 1046 and the interior peg hole 112 of the interior pole 104A such that it fixes the position of the exterior pole 1046 and interior pole 104A. The flexible strap 502 is then wrapped around the exterior surface of the exterior telescopic pole 1046 to secure the peg 504 once it has been inserted.

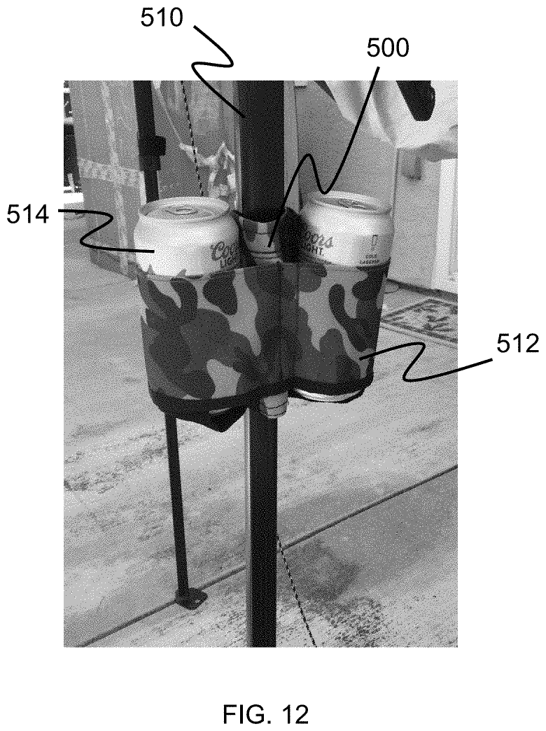

FIG. 12 is an image of the pole attachment device 500 with an attached accessory 512 in the form of a set of flexible pouches capable of holding beverage cans 514 or other containers such as bottles, canteens or a thermos. The accessory 512 may be attached with the flexible strap and made from a similar flexible but durable material that is capable of retaining any type of object. The accessory 512 may be of any shape, such as a sleeve, hook, clip, etc., and configured to retain a multitude of objects that a user may want to access while utilizing the canopy tent. In this embodiment, the accessory 512 is fixedly attached to the flexible strap, although other types of accessories could be removably attached to provide flexible options for a user to add and remove any type of desired accessory. The accessory is capable of retaining a substantial weight and volume of material as a result of the peg being inserted into the peg hole of the perforated pole 510 and the flexible strap further securing the attachment device to the perforated pole with the fastening mechanism.

FIG. 13 illustrates the pole attachment device and attached accessory 512 as the device is being fixed to the perforated pole 510. In this embodiment, the peg 504 has already been inserted into the peg hole of the pole 510, and the base portion 516 of the peg is shown on the opposing side of the flexible strap 502, which, as mentioned above, may be a grommet or other attachment mechanism used to fix the peg with the flexible strap 502.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A device for attaching with a perforated pole, the device comprising:
a flexible strap with a fastening mechanism for fastening one portion of the flexible strap with a second portion of the flexible strap; and
a peg secured with the flexible strap on a first end and protruding substantially perpendicularly from the flexible strap.

2. The device of claim 1, further comprises an accessory attached with the flexible strap.

3. The device of claim 2, wherein the accessory is one or more of a cup holder, pouch, pocket, hook, strap, holder, or water dispenser.

3. The device of claim 1, wherein the fastening mechanism is a fabric adhesive material.

4. The device of claim 1, wherein the peg is threaded, barbed or smooth.

5. The device of claim 1, wherein the peg includes a base portion of a larger diameter which is secured within at least two layers of fabric of the flexible strap.

6. A method of attaching an accessory with a perforated pole, the method comprising:
position peg attached with a flexible strap and accessory over an exterior peg hole of a perforated pole;
insert peg into the exterior peg hole;
wrap the flexible strap with the attached accessory around an exterior surface of the perforated pole; and
fasten the flexible strap to secure the accessory to the perforated pole.

7. The method of claim 6, wherein the accessory is at least one cup holder.

8. The method of claim 7, wherein the cup holder is a flexible fabric material.

9. The method of claim 6, wherein the accessory is at least one of a pouch, pocket, hook and loop.

10. A method of repairing a telescopic pole, the method comprising:
aligning an interior peg hole on an interior pole with an exterior peg hole on an exterior pole of a telescopic pole assembly;
insert a peg attached with a flexible strap into the exterior peg hole and interior peg hole;
wrap the flexible strap around an exterior surface of the exterior pole; and
fasten the flexible strap around the exterior pole to secure the peg in the peg hole.

11. The method of claim 10, further comprising fastening the flexible strap to the exterior pole with a fabric adhesive material.

12. The method of claim 10, further comprising inserting a peg with threads into the interior peg hole and exterior peg hole.
